(19) United States
(12) Patent Application Publication
(10) Pub. No.: US 2025/0320889 A1
(43) Pub. Date: Oct. 16, 2025

(54) FASTENER

(71) Applicant: PEGATRON CORPORATION, Taipei City (TW)

(72) Inventors: Chi-Yao CHAO, Taipei City (TW); Di-Yang WANG, Taipei City (TW); Che-Wei HSU, Taipei City (TW); Tsung-Yueh YU, Taipei City (TW); Chien-Chung CHUEH, Taipei City (TW)

(21) Appl. No.: 18/976,815

(22) Filed: Dec. 11, 2024

(30) Foreign Application Priority Data
Apr. 12, 2024 (TW) 113113873

(51) Int. Cl. F16B 21/06

(52) U.S. Cl. CPC F16B 21/065

(57) ABSTRACT

A fastener includes a first assembly and a second assembly detachably connected to each other. The second assembly includes an upper housing, a lower housing, a button, a fixing set and a stopper. The fixing set includes a first fixing member and a second fixing member and is adapted to engage with an engaging structure of the first assembly. The stopper is connected to the button to limit the engagement of the fixing set and the engaging structure. When the button moves along a first axis, the button drives the stopper to move to release the engagement of the fixing set and the engaging structure. Then, when the first assembly moves away from the second assembly, the engaging structure causes the first fixing member and the second fixing member approaching each other along a second axis, until the fixing set is separated from the engaging structure.

### CROSS REFERENCE TO RELATED APPLICATIONS

This Non-provisional application claims priority under 35 U.S.C. § 119(a) on Patent Application No(s). 113113873 filed in Taiwan, Republic of China on Apr. 12, 2024, the entire contents of which are hereby incorporated by reference.

### BACKGROUND

### Technology Field

The present disclosure relates to a fastener and, in particular, to a push-type clip fastener.

### Description of Related Art

The conventional push-type clip fastener mainly uses the combination of a hook and a groove to achieve the purpose of hooking and fixing by the elasticity and toughness of plastic material. However, the conventional fastener mainly has the following two problems.

First of all, in most push-type clip fasteners including the design of hooks and grooves, the hook needs to have a certain toughness to support the hooking status, and needs to elastically deform for performing the disengaging process. Therefore, most hooks are made of plastic materials. However, the hooks made of plastic materials may have, after the long-term operations or collisions, a high risk of breakage.

Secondly, since the button position of the conventional push-type clip fastener must be matched with the hook and groove, the male and female parts of most fasteners cannot be relatively rotated when in the fastened state. Therefore, in the case of cooperating with a strap, since the male and female parts of the conventional fastener are unable to relatively rotate with each other to match the pulling direction of the strap, the strap may be folded and have uneven parts, which may affect wearing comfortability.

### SUMMARY

In view of the foregoing, this disclosure is to provide a fastener that can improve the problem of hook breakage due to the elastic deformation property of the hook for fastening.

A fastener of this disclosure includes a first assembly and a second assembly. The first assembly includes an engaging structure. The second assembly is detachably connected to the first assembly, and the second assembly includes an upper housing, a lower housing, a button, a fixing set and a stopper. The upper housing has a first side and a second side opposite to the first side. The lower housing is disposed at the second side of the upper housing. The button is disposed at the first side of the upper housing and adapted to move along a first axis. The fixing set is disposed at the second side of the upper housing and includes a first fixing member and a second fixing member, which are relatively movable along a second axis with relative to each other. The first fixing member and the second fixing member are adapted to engage with the engaging structure, and the second axis is perpendicular to the first axis. The stopper is disposed at the second side of the upper housing and connected to the button. The stopper is located between the first fixing member and the second fixing member and is adapted to limit or release an engagement of the first fixing member and the second fixing member with the engaging structure. When the button moves relative to the upper housing along the first axis, the button drives the stopper to move to release the engagement of the first fixing member and the second fixing member with the engaging structure. Then, when the first assembly moves away from the second assembly along the first axis, the engaging structure pushes the fixing set to cause the first fixing member and the second fixing member approaching each other along the second axis, until the fixing set is separated from the engaging structure.

In one embodiment, the upper housing includes a recess, and the fastener further includes an elastic member disposed in the recess.

In one embodiment, the button includes a pressed portion, and two ends of the elastic member contact against the pressed portion and the upper housing, respectively.

In one embodiment, the button further includes a connection portion connected with the pressed portion, and the connection portion penetrates through the upper housing and is connected to the stopper.

In one embodiment, the first axis is parallel to an extension direction of the connection portion.

In one embodiment, the first fixing member and the second fixing member are disposed between the stopper and the lower housing.

In one embodiment, the stopper includes a stopping surface, the first fixing member has a first hooking surface, the second fixing member has a second hooking surface, the stopping surface is adapted to contact against the first hooking surface of the first fixing member and the second hooking surface of the second fixing member.

In one embodiment, the lower housing includes a contact portion, and the first fixing member and the second fixing member contact against the contact portion.

In one embodiment, when the button moves along the first axis, the stopper moves away from the upper housing, so that a gap is formed between the stopping surface and the first fixing member and between the stopping surface and the second fixing member, and the gap is adapted to release the engagement of the first fixing member and the second fixing member with the engaging structure.

In one embodiment, when the second assembly is connected to the first assembly, the first assembly and the second assembly are relatively rotatable with each other.

As mentioned above, the fastener of this disclosure can achieve the engagement without utilizing the elastic deformation property of the hook as the conventional fastener, thereby reducing the breakage risk of the hook.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing a fastener according to an embodiment of this disclosure;

FIG. 1B is an exploded view of the fastener of FIG. 1A;

FIG. 2A and FIG. 2B are sectional views of the fastener of FIG. 1A before and after the button is pressed;

FIG. 2C is an enlarged view of an area as shown in FIG. 2B; and

FIG. 3A to FIG. 3D are schematic diagrams showing the separation procedures of the first assembly and the second assembly of the fastener of FIG. 1A.

### DETAILED DESCRIPTION OF THE DISCLOSURE

The present disclosure will be apparent from the following detailed description, which proceeds with reference to the accompanying drawings, wherein the same references relate to the same elements.

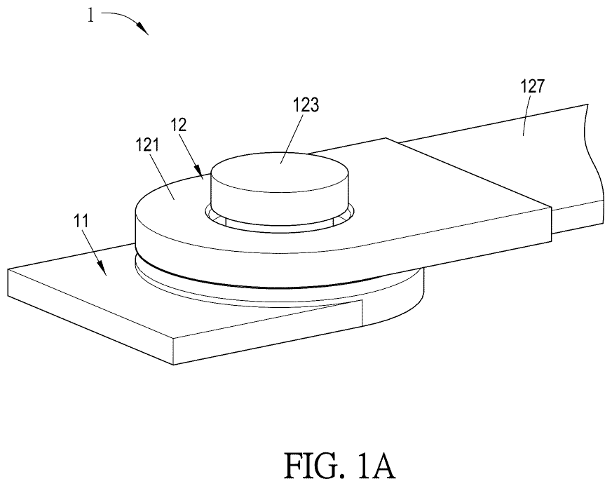

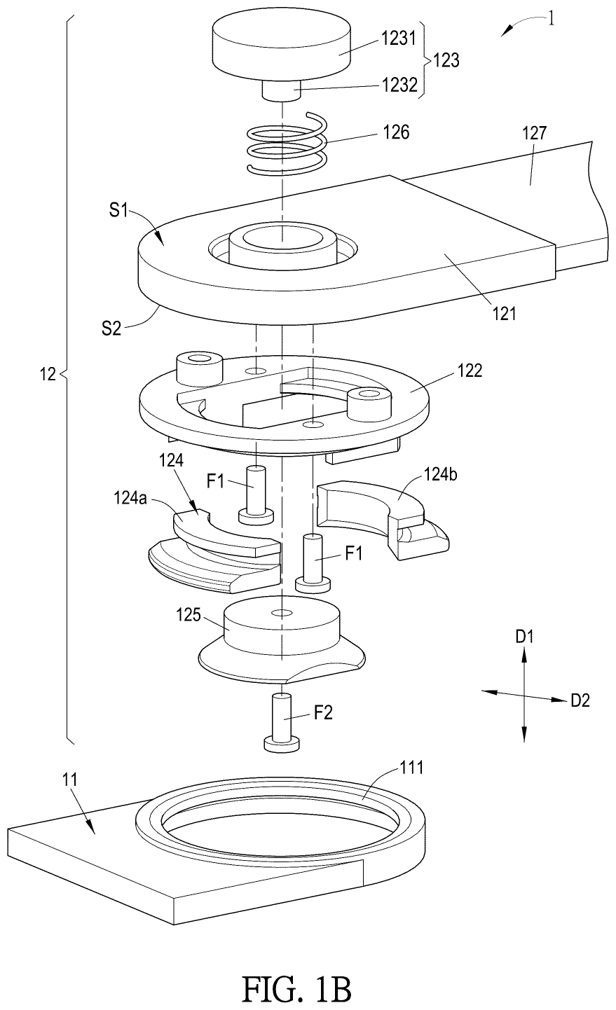

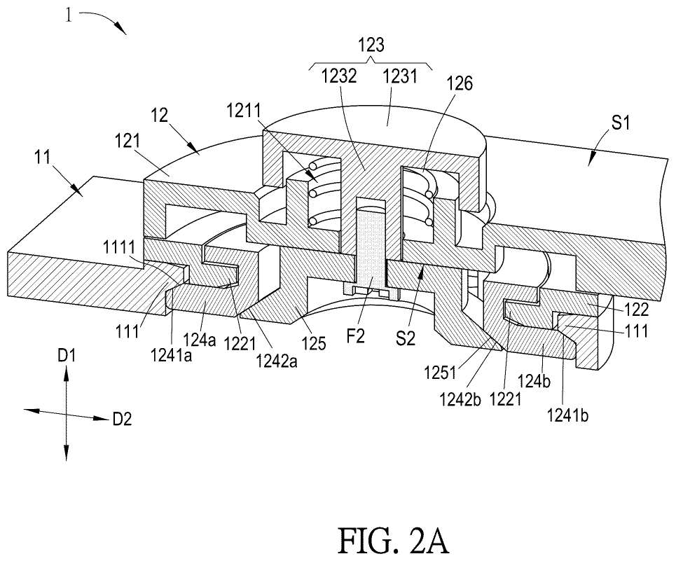

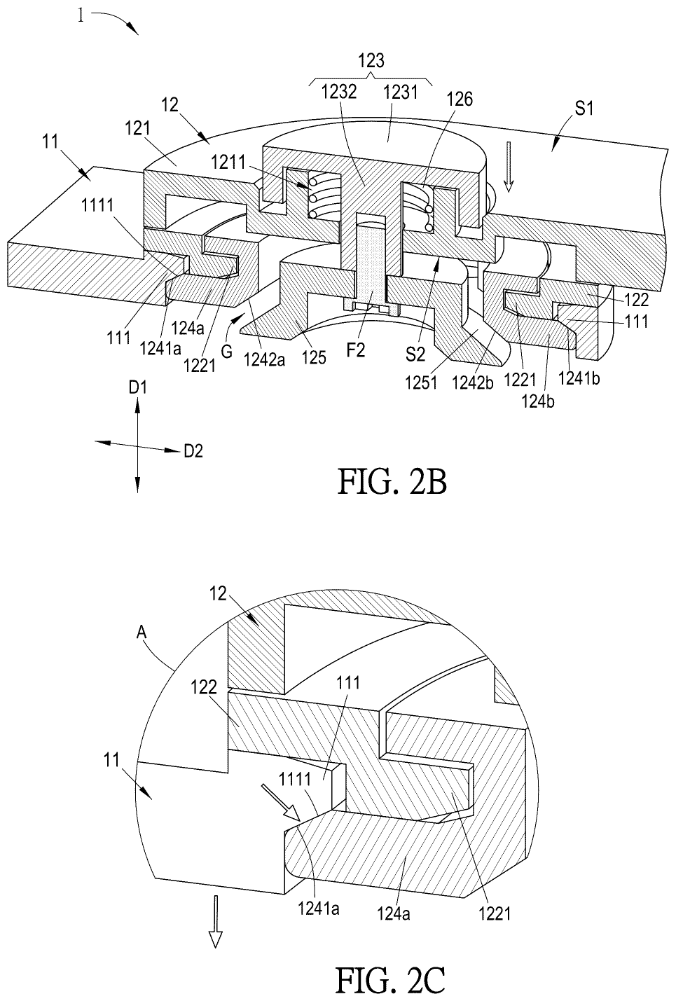

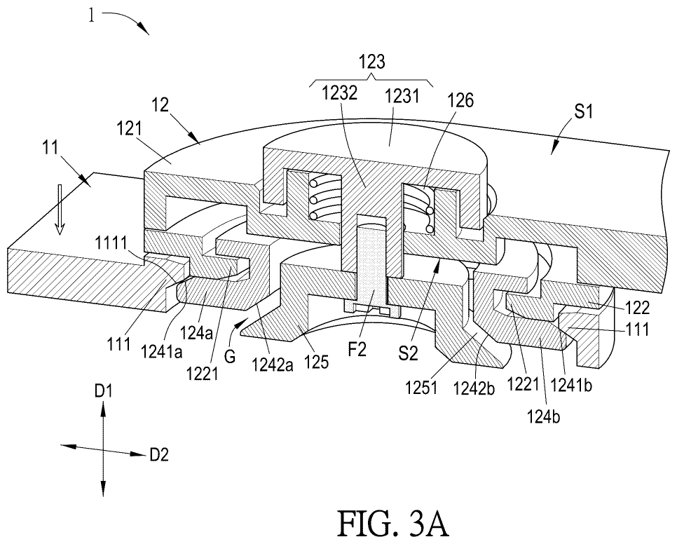

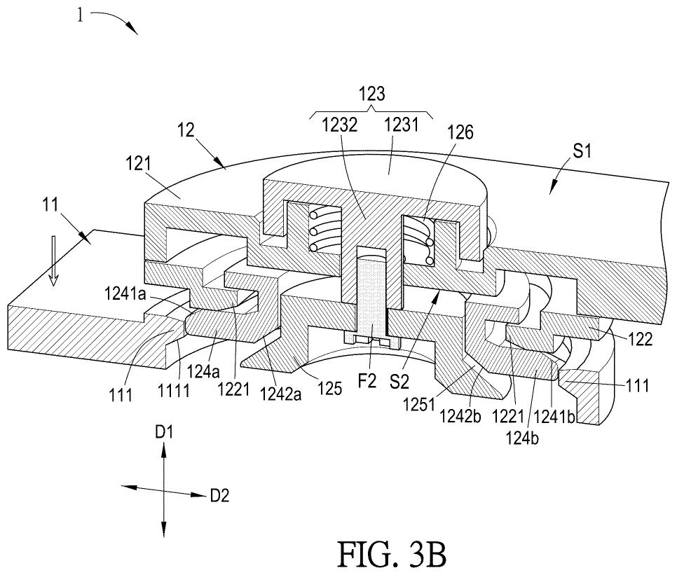

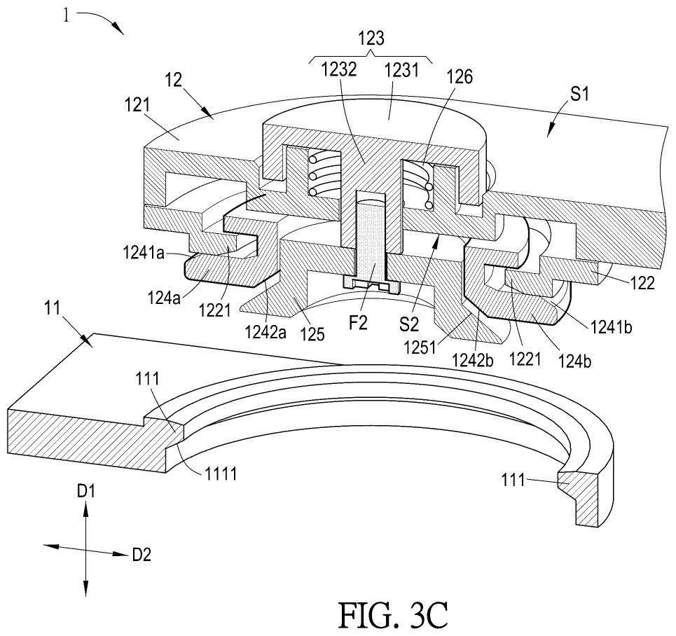

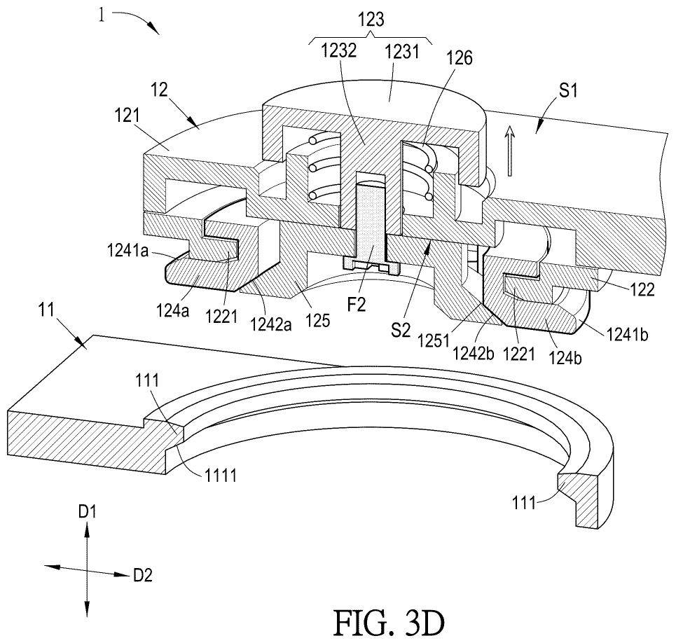

FIG. 1A is a schematic diagram showing a fastener according to an embodiment of this disclosure, and FIG. 1B is an exploded view of the fastener of FIG. 1A. FIG. 2A and FIG. 2B are sectional views of the fastener of FIG. 1A before and after the button is pressed, and FIG. 2C is an enlarged view of an area as shown in FIG. 2B. FIG. 3A to FIG. 3D are schematic diagrams showing the separation procedures of the first assembly and the second assembly of the fastener of FIG. 1A.

Referring to FIGS. 1A, 1B, 2A and 2B, the fastener 1 of this embodiment includes a first assembly 11 and a second assembly 12, and the second assembly 12 is detachably connected to the first assembly 11. Specifically, the second assembly 12 and the first assembly 11 can be engaged and connected to each other. In the engagement status, the first assembly 11 and the second assembly 12 are relatively rotatable with each other.

The first assembly 11 includes an engaging structure 111. In this embodiment, the engaging structure 111 has a continuous structure. In other words, the engaging structure 111 is an annular hook structure. The engaging structure 111 with the annular hook structure allows the first assembly 11 and the second assembly 12 to be relatively rotatable for 360 degrees or more. In different embodiments, the engaging structure 111 can be a non-continuous structure. That is, the engaging structure 111 is a non-annular structure and has one or more breaks. Accordingly, the engaging structure 111 can be designed as a non-continuous structure (i.e., non-annular) based on the designer's needs to limit the relative rotatable angle of the first assembly 11 and the second assembly 12.

The second assembly 12 includes an upper housing 121, a lower housing 122, a button 123, a fixing set 124, and a stopper 125. In addition, the second assembly 12 of this embodiment may further include an elastic member 126 and a connection member 127.

The upper housing 121 has a first side S1 (e.g. the upper side) and a second side S2 (e.g. the lower side) opposite to the first side S1. The lower housing 122 is disposed at the second side S2 of the upper housing 121. As shown in FIG. 1B, the lower housing 122 of this embodiment is fixed on the second side S2 of the upper housing 121 by two screws F1. The connection member 127 is connected to the upper housing 121. In one embodiment, the connection member 127 can be, for example but not limited to, a strap.

The button 123 is disposed at the first side S1 of the upper housing 121, and is adapted to move along a first axis D1. The stopper 125 is disposed at the second side S2 of the upper housing 121 and is connected to the button 123. In addition, one side of the upper housing 121 facing toward the button 123 is configured with a recess 1211, and the elastic member 126 is disposed in the recess 1211. In this case, the elastic member 126 is a spring. When the button 123 is pressed downwardly along the first axis D1 to make the button 123 approach the upper housing 121 (FIG. 2B), the elastic member 126 can provide a force (elastic force) to push the button 123 away from the upper housing 121 along the first axis D1.

In this embodiment, the button 123 has a pressed portion 1231, and two ends of the elastic member 126 contact against the pressed portion 1231 and the upper housing 121, respectively. Accordingly, when the button 123 is pressed and moves downwardly, the force of the elastic member 126 can be provided to push the button 123 away from the upper housing 121. In addition, the button 123 of this embodiment further has a connection portion 1232 connected to the pressed portion 1231. The extension direction of the connection portion 1232 is parallel to the above-mentioned first axis D1. The connection portion 1232 penetrates the elastic member 126 and the upper housing 121 to connect to the stopper 125.

The fixing set 124 is disposed at the second side S2 of the upper housing 121 and includes a first fixing member 124a and a second fixing member 124b. The first fixing member 124a and the second fixing member 124b are relatively movable along a second axis D2 with relative to each other. The second axis D2 is perpendicular to the first axis D1. The first fixing member 124a and the second fixing member 124b have the same arc structures, and are disposed between the stopper 125 and the lower housing 122. In addition, the first fixing member 124a and the second fixing member 124b are also disposed between the stopper 125 and the engaging structure 111. The lower housing 122 is disposed between the fixing set 124 (including the first fixing member 124a and the second fixing member 124b) and the engaging structure 111.

The first fixing member 124a and the second fixing member 124b are disposed corresponding to the engaging structure 111, and the first fixing member 124a and the second fixing member 124b are adapted to engage with the engaging structure 111. As shown in FIG. 2A, in this embodiment, when the second assembly 12 is connected (engaged) to the first assembly 11, the first assembly 11 is disposed around the periphery of the fixing set 124 (including the first fixing member 124a and the second fixing member 124b), and the engaging structure 111 of the first assembly 11 is engaged with the fixing set 124 (including the first fixing member 124a and the second fixing member 124b). In addition, the first fixing member 124a and the second fixing member 124b can move closing to or away from each other along the second axis D2. Specifically, the first fixing member 124a and the second fixing member 124b can move between the stopper 125 and the lower housing 122 to approach each other or to move away from each other. The detailed description of this movement will be further described hereinafter.

The stopper 125 is disposed between the first fixing member 124a and the second fixing member 124b, and is adapted to limit or release the engagement of the first fixing member 124a and the second fixing member 124b with the engaging structure 111. In this embodiment, the stopper 125 has an annular symmetrical structure and is connected to the connection portion 1232 of the button 123. As shown in FIG. 1B, the stopper 125 is fixedly connected to the connection portion 1232 through screws F2. In addition, the stopper 125 of this embodiment has a stopping surface 1251, the first fixing member 124a has a first hooking surface 1241a, and the second fixing member 124b has a second hooking surface 1241b. When the button 123 is not pressed by external force (see FIG. 2A), the stopping surface 1251 contacts against the first fixing member 124a and the second fixing member 124b, so that the first hooking surface 1241a of the first fixing member 124a and the second hooking surface 1241b of the second fixing member 124b are engaged with the engaging structure 111, thereby limiting the engagement between the fixing set 124 and the engaging structure 111.

In this embodiment, the stopping surface 1251 is an inclined surface, and the first fixing member 124a and the second fixing member 124b respectively have fixing portions 1242a and 1242b facing the stopping surface 1251 and corresponding in shape to the stopping surface 1251. In addition, the first hooking surface 1241a and the second hooking surface 1241b of this embodiment are also inclined surfaces respectively, and the engaging structure 111 further has an engaging surface 1111 facing the first hooking surface 1241a and the second hooking surface 1241b and corresponding in shape to the first hooking surface 1241a and the second hooking surface 1241b. Therefore, when the button 123 is not pressed by an external force, the stopping surface 1251 of the stopper 125 can contact against the fixing portion 1242a of the first fixing member 124a and the fixing portion 1242b of the second fixing member 124b, so that the first hooking surface 1241a of the first fixing member 124a and the second hooking surface 1241b of the second fixing member 124b can engage with the engaging surface 1111 of the engaging structure 111. In addition, the lower housing 122 of this embodiment has a contact portion 1221, and the first fixing member 124a and the second fixing member 124b further contact against the contact portion 1221. In this case, the first fixing member 124a and the second fixing member 124b facing the contact portion 1221 correspond in shape to and cooperate with the contact portion 1221. Therefore, the first fixing member 124a and the second fixing part 124b can individually contact against the contact portion 1221.

Referring to FIG. 2A in view of FIGS. 2B and 2C, when the user presses the button 123 to move the button 123 downwardly along the first axis D1 relative to the upper housing 121, the button 123 can drive the stopper 125 to move downwardly along the first axis D1 away from the upper housing 121. At this time, the stopping surface 1251 of the stopper 125 will be separated from the fixing portion 1242a of the first fixing member 124a and the fixing portion 1242b of the second fixing member 124b. Accordingly, a gap G can be generated between the stopper 125 and the first fixing member 124a and between the stopper 125 and the second fixing member 124b. The gap G is adapted to release the engagement of the first fixing member 124a and the second fixing member 124b with the engaging structure 111. After the gap G is generated, the user can further pull the first assembly 11 to move away from the second assembly 12 along the first axis D1. In more detailed, when the force is applied by the user to separate the first assembly 11 from the second assembly 12, the fixing set 124 can be pushed by the engaging surface 1111 of the engaging structure 111. That is, the component force generated from the force applied by the user along the first axis D1 causes the engaging surface 1111 of the engaging structure 111 to push the first hooking surface 1241a of the first fixing member 124a and the second hooking surface 1241b of the second fixing member 124b (see FIG. 2C), so that the first fixing member 124a and the second fixing member 124b are moved approaching each other along the second axis D2 perpendicular to the first axis D1. In other words, the first fixing member 124a and the second fixing member 124b are moved close to the central line. At this time, the engaging surface 1111 of the engaging structure 111 can be separated from the first fixing member 124a and the second fixing member 124b. The first fixing member 124a and the second fixing member 124b are kept in this position until the fixing set 124 (including the first fixing member 124a and the second fixing member 124b) is separated from the engaging structure 111.

To be noted, when the user presses the button 123, this pressing action does not drive the first fixing member 124a and the second fixing member 124b to move approaching each other. The user must apply extra force to generate component forces between the engaging structure 111 and the first hooking surface 1241a of the first fixing member 124a and between the engaging structure 111 and the second hooking surface 1241b of the second fixing member 124b along the second axis D2, thereby making the first fixing member 124a and the second fixing member 124b approach each other. Then, the engagement between the first fixing member 124a and the second fixing member 124b with the engaging structure 111 can be released (loosened), and the engaging structure 111 and the fixing set 124 can be separated. Thus, the possibility that the user accidentally touches the button 123 to unlock the fastener 1 can be reduced.

The separation procedures of the first assembly 11 and the second assembly 12 of the fastener 1 will be described hereinafter with reference to FIGS. 2A to 2C in view of FIGS. 3A to 3D. In the following description, the first assembly 11 can be realized as a female part, and the second assembly 12 can be realized as a male part.

The separation procedures (steps) of the first assembly 11 (female part) and the second assembly 12 (male part) will be described below. To be understood, the assembling procedures (steps) of the first assembly 11 (female part) and the second assembly 12 (male part) are the reverse procedures (steps) of the separation procedures (steps).

In a first step, as shown in FIGS. 2A to 2C, when the first assembly 11 and the second assembly 12 are engaged with each other, the button 123 is pressed downwardly along the first axis D1 to move the stopper 125 downwardly, thereby generating a gap G between the stopping surface 1251 of the stopper 125 and the fixing member 124a and between the stopping surface 1251 of the stopper 125 and the second fixing member 124b.

In the second step, as shown in FIGS. 2B and 2C, while continuing to press the button 123, the user applies extra force to separate the first assembly 11 and the second assembly 12 from each other along the first axis D1. When the button 123 is pressed, the gap G exists between the stopper 125 and the first fixing member 124a and between the stopper 125 and the second fixing member 124b. During the separation of the first assembly 11 and the second assembly 12, the engaging structure 111 of the first assembly 11 can apply force on the first hooking surface 1241a of the first fixing member 124a and the second hooking surface 1241b of the second fixing member 124b, such that the first fixing member 124a and the second fixing member 124b move close to each other. As shown in FIGS. 3A and 3B, the first fixing member 124a and the second fixing member 124b will be moved close to each other along the second axis D2.

In the third step, the first assembly 11 and the second assembly 12 are continuously separated until the first assembly 11 and the second assembly 12 are completely separated (see FIG. 3C).

Finally, in the fourth step, as shown in FIG. 3D, the user releases the button 123, so that the elastic member 126 can provide an elastic force to push the button 123 and the stopper 125 to move upwardly. At this time, the stopping surface 1251 of the stopper 125 can push the first fixing member 124a and the second fixing member 124b, such that the first fixing member 124a and the second fixing member 124b move away from each other. Finally, the second assembly 12 (male part) is returned to the initial stable state.

In this embodiment, since the first assembly 11 and the second assembly 12 are designed as circular symmetrical structures, the first assembly 11 and the second assembly 12 can be rotatable relative to each other in the engagement state. Moreover, the relative rotation angle of the first assembly 11 and the second assembly 12 in the plane perpendicular to the first axis D1 are not limited.

As mentioned above, in the fastener 1 of this embodiment, the female part (the first assembly 11) and the male part (the second assembly 12) are not assembled based on the plastic toughness and elastic deformation used in the conventional push-type clip fastener. Moreover, the fixing set 124 (including the first fixing member 124a and the second fixing member 124b) of this embodiment can be made of a stronger material (e.g. metal) according to actual requirements to greatly improve the stability, durability and reliability of the fastener 1. In addition, in this embodiment, the elastic member 126 and the movable first fixing member 124a and second fixing member 124b are provided, and the first assembly 11 and the second assembly 12 have annular symmetrical structural design. Therefore, the second assembly 11 and the second assembly 12 have more freedom of adjustment (rotation) during the assembling procedures or in the engagement state. The fastener 1 of this embodiment can greatly expand its application scope and use occasions when cooperating with the connection member 127 (strap), and can also be used in fastening occasions and needs where the male part and female part need to be relatively rotatable.

To be understood, in different embodiments, if the relative rotation angle of the first assembly 11 and the second assembly 12 needs to be limited due to design requirements, the engaging structure 111 of the first assembly 11 can be designed as a discontinuous structure, thereby limiting the relative rotation angle of the first assembly 11 and the second assembly 12.

In summary, in the fastener of this disclosure, the second assembly is detachably connected to the first assembly, and the button of the second assembly is adapted to move along a first axis. The fixing set includes a first fixing member and a second fixing member, which are relatively movable along a second axis with relative to each other. The first fixing member and the second fixing member are adapted to engage with the engaging structure of the first assembly, and the stopper is connected to the button and is adapted to limit or release an engagement of the first fixing member and the second fixing member with the engaging structure. When the button moves relative to the upper housing along the first axis, the button drives the stopper to move to release the engagement of the first fixing member and the second fixing member with the engaging structure. When the first assembly moves away from the second assembly along the first axis, the engaging structure pushes the fixing set to cause the first fixing member and the second fixing member approaching each other along the second axis, until the fixing set is separated from the engaging structure. Based on the above-mentioned design, the fastener of this disclosure is not assembled based on the elastic deformation of the hook used in the conventional push-type clip fastener, thereby reducing the breakage risk of the hook. Moreover, the female part (the first assembly) and the male part (the second assembly) are relatively rotatable to increase the wearing comfort.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A fastener, comprising:
a first assembly comprising an engaging structure; and
a second assembly detachably connected to the first assembly, wherein the second assembly comprises:
an upper housing having a first side and a second side opposite to the first side;
a lower housing disposed at the second side of the upper housing;
a button disposed at the first side of the upper housing and adapted to move along a first axis;
a fixing set disposed at the second side of the upper housing and comprising a first fixing member and a second fixing member, wherein the first fixing member and the second fixing member are relatively movable along a second axis with relative to each other, the first fixing member and the second fixing member are adapted to engage with the engaging structure, and the second axis is perpendicular to the first axis; and
a stopper disposed at the second side of the upper housing and connected to the button, wherein the stopper is located between the first fixing member and the second fixing member and is adapted to limit or release an engagement of the first fixing member and the second fixing member with the engaging structure;
wherein, when the button moves relative to the upper housing along the first axis, the button drives the stopper to move to release the engagement of the first fixing member and the second fixing member with the engaging structure, and then, when the first assembly moves away from the second assembly along the first axis, the engaging structure pushes the fixing set to cause the first fixing member and the second fixing member approaching each other along the second axis, until the fixing set is separated from the engaging structure.

2. The fastener of claim 1, wherein the upper housing comprises a recess, and the fastener further comprises:
an elastic member disposed in the recess.

3. The fastener of claim 2, wherein the button comprises a pressed portion, and two ends of the elastic member contact against the pressed portion and the upper housing, respectively.

4. The fastener of claim 3, wherein the button further comprises a connection portion connected with the pressed portion, and the connection portion penetrates through the upper housing and is connected to the stopper.

5. The fastener of claim 4, wherein the first axis is parallel to an extension direction of the connection portion.

6. The fastener of claim 1, wherein the first fixing member and the second fixing member are disposed between the stopper and the lower housing.

7. The fastener of claim 1, wherein the stopper comprises a stopping surface, the first fixing member has a first hooking surface, the second fixing member has a second hooking surface, the stopping surface is adapted to contact against the first hooking surface of the first fixing member and the second hooking surface of the second fixing member.

8. The fastener of claim 7, wherein the lower housing comprises a contact portion, the first fixing member and the second fixing member contact against the contact portion.

9. The fastener of claim 7, wherein when the button moves along the first axis, the stopper moves away from the upper housing, so that a gap is formed between the stopping surface and the first fixing member and between the stopping surface and the second fixing member, and the gap is adapted to release the engagement of the first fixing member and the second fixing member with the engaging structure.

10. The fastener of claim 1, wherein when the second assembly is connected to the first assembly, the first assembly and the second assembly are relatively rotatable with each other.
